(19) United States
(12) Patent Application Publication
(10) Pub. No.: US 2019/0061800 A1
(43) Pub. Date: Feb. 28, 2019

(54) Ski Scooter Device

(71) Applicant: Robert Carrig, Forest Hills, NY (US)

(72) Inventor: Robert Carrig, Forest Hills, NY (US)

(21) Appl. No.: 16/118,180

(22) Filed: Aug. 30, 2018

Related U.S. Application Data
(60) Provisional application No. 62/552,337, filed on Aug. 30, 2017.

(51) Int. Cl. B62B 13/04; A63B 69/18; B62B 17/06

(52) U.S. Cl. CPC B62B 13/046; B62B 17/065; A63B 69/18

(57) ABSTRACT

Embodiments for a ski scooter device are provided. The scooter includes a central ski, a central platform, two outrigger skis, a suspension system, and a steering mechanism. Generally speaking, these components are structured such central platform is attached on top of the central ski, the steering mechanism is attached to the central platform and the suspension system, and the suspension system is attached to the two outrigger skis.

### CROSS-REFERENCE TO RELATED APPLICATIONS

This application claims priority to U.S. Provisional Application No. 62/552,337 filed Aug. 30, 2017. The content of the above application is hereby expressly incorporated by reference herein in its entirety.

### FIELD OF DISCLOSURE

This disclosure relates generally to the field of recreational sports equipment. More specifically, this disclosure relates to a ski scooter device.

### BACKGROUND

Young children can participate in snow tubing and sledding, but this does not teach basic skiing skills. Day-long ski schools attempt to teach the basics of skiing and snowboarding, but strapping the child into skis or snowboards can significantly limit their movement and enjoyment of winter sports. Other solutions attempt to use three connected skis, but these solutions are unable to teach basic skiing skills as the skis are not maintained on the same plane and do not turn with respect to each other. Still other solutions seek to use two skis one in front of the other, but these solutions provide a very unstable platform, are much more likely to sink into soft snow, and do not mimic natural skiing motions.

### SUMMARY

The disclosure presented herein relates to a ski scooter device. In one, non-limiting embodiment, the ski scooter device may have a central ski, two outrigger skis, a central platform, a suspension system, and a steering mechanism. The ski scooter device may have a torsion spring system and a steering column.

### BRIEF DESCRIPTION OF THE DRAWINGS

The present invention will be described by way of exemplary embodiments, but not limitations, illustrated in the accompanying drawings in which like references denote similar elements, and in which:

FIG. 1 is a perspective view depicting the ski scooter device according to one embodiment.

FIG. 2 is a front view depicting the ski scooter device of FIG. 1.

FIG. 3 is a front view depicting the ski scooter device of FIG. 1.

FIG. 4 is an isometric perspective view of the ski scooter device of FIG. 1.

### DETAILED DESCRIPTION

In the Summary above, this Detailed Description, the claims below, and in the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)−(a second number),” this means a range having a lower limit and an upper limit corresponding to the first number and the second number, respectively. For example, 25 to 100 mm means a range whose lower limit is 25 mm and upper limit is 100 mm.

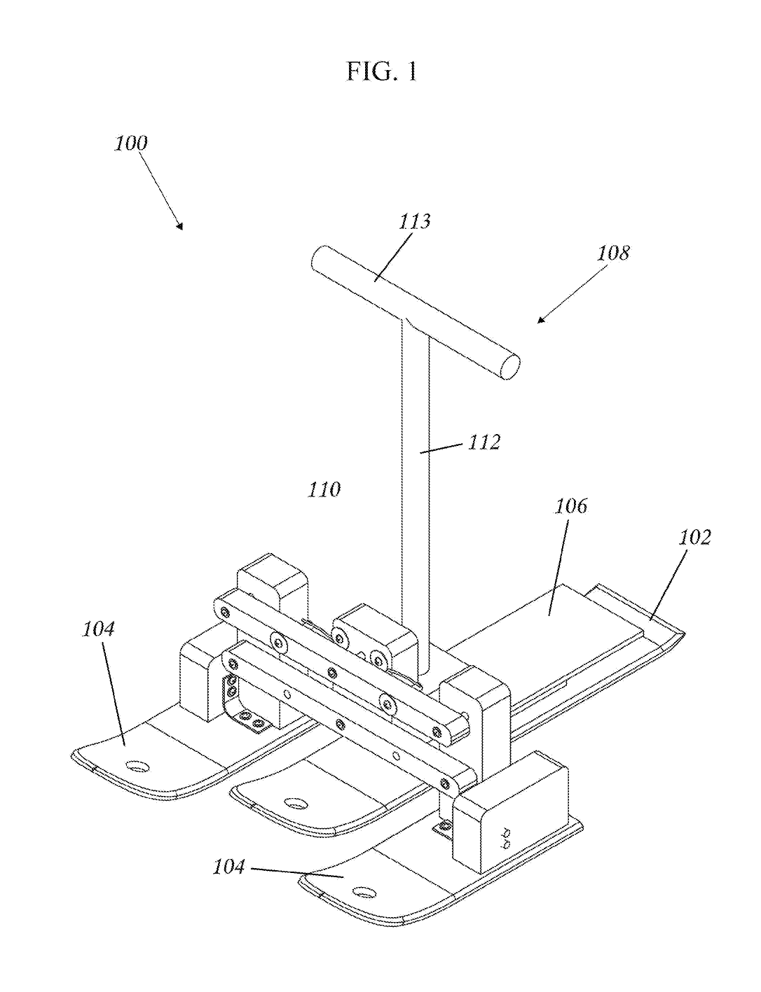

FIGS. 1-4 depict a ski scooter device (“scooter”) 100. In one or more non-limiting embodiments, the scooter 100 may have a central ski 102, two outrigger skis 104, a central platform 106, a steering mechanism 108, and a suspension system 110. The central ski 102 and the two outrigger skis 104 may be attached to a suspension system 110 and arranged such that the nose of the central ski 102 is positioned between the two outrigger skis 104. The central ski 102 may function as a central base and mimic the functionality and movements of a ski or snowboard. The two outrigger skis 104 may provide additional stability to allow a rider to stand upright or sit on the scooter 100 without frequently falling over. This allows the rider to safely learn the basic movement mechanics involved in skiing or snowboarding and quickly build up confidence on the snow.

Referring now to FIG. 1, a perspective view is shown depicting the scooter 100 may. In one or more non-limiting embodiments, the central ski 102 may be longer than the two outrigger skis 104 and act as a centralized base. As a centralized base, the central ski 102 can function like wide ski or a small snowboard. Accordingly, the central ski 102 may have a traditional camber with contact points near the nose and tail of the central ski 102, similar to that of skis or snowboards with a traditional camber. In other embodiments, the central ski 102 may have a reverse camber or rocker camber with the main contact point of the base located at the center of the central ski 102.

In one or more non-limiting embodiments, the scooter 100 may have a central platform 106 that may be attached on top of the central ski 102. In some embodiments, the central platform 106 may have a coating, such as a skateboard grip tape, that sloughs snow while providing traction and stability for a rider standing on the central platform 106. In other embodiments, the central platform 106 may have a skeletal frame featuring a weaved or waffled design that allows snow to fall through the central platform 106 and prevent snow clumping or buildup on the central platform 106. A rider may stand or sit on the central platform 106. In some embodiments, the central platform 106 may be fastened on top of the central ski 102 and later removed if the rider, such as a child, outgrows the central platform 106 or wants a more tactile or board-to-slope feel beneath the rider's feet.

The scooter 100 may also have a steering mechanism 108 such as a handle bar or a steering wheel that provides easy steering and stabilization of the scooter 100 when in use. The steering mechanism 108 may be attached to the suspension system 110 and may sit on top of the central platform 104. The suspension system 110 may be attached to the outrigger skis 104 and may control the angular or turn initiation movements of the outrigger skis 104. A rider may initiate turns by manipulating the steering mechanism 108, which in turn causes the suspension system 110 to move the outrigger skis 104 resulting in a turn. For instance, the steering mechanism 104 may have a steering column 112 and a handle bar 113. A rider may turn or tilt the handle bar 113 left to turn left on the scooter 100 going down a mountain slope. In some embodiments, the steering mechanism 108 may have an adjustable steering column or may be folded down for easier transporting and storage.

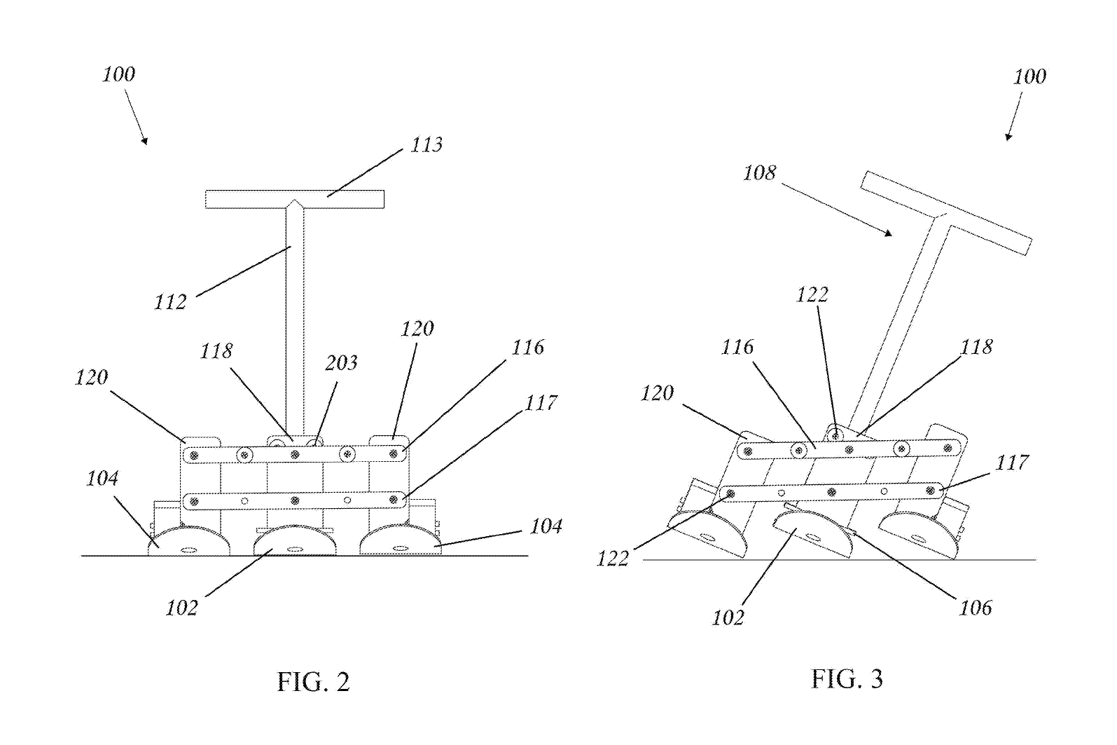

Referring now to FIG. 2, a front view is shown depicting the scooter 100 in an upright position. In one or more embodiments, the scooter 100 may have a suspension system 110 that facilitates turn initiation for the scooter 100 working in tandem with the steering mechanism 108. The suspension system 108 may be a parallelogram suspension 114 which may have an upper horizontal member 116 and a lower horizontal member 117 that are parallel to each other. The upper horizontal member 116 and the lower horizontal member 117 may be attached to a central vertical block 118 and two outer vertical blocks 120. The scooter 100 may also have a torsion spring system 122 that may be fastened to the parallelogram suspension and the central and outer vertical blocks 118, 120. The torsion spring system 122 may have various fasteners such as screws, springs, nuts, and bolts. The central vertical block 118 may be attached to the upper and lower horizontal members 116, 117 with at least one nut and one bolt. The two outer vertical blocks 120 may also be attached to the upper and lower horizontal members 116, 117 by at least one nut and one bolt. The two outer vertical blocks 120 may be attached on top of the two outrigger skis 104 so that each of the two outer vertical blocks 120 are attached to only one of the two outrigger skis 104.

Referring now to FIG. 3, a front view is shown depicting the scooter 100 leaning at an angle. The scooter 100 may be used to increase movement awareness on a snowboard or a pair of skis because the scooter 100 can move with the same or similar basic mechanics of a regular snowboard or skis. The torsion spring system 122 within the suspension system 110 allows a natural, ski- or snowboard-like turn initiation. For instance, when a rider turns or tilts the steering mechanism 108 such as a handle bar 113 to the left, the torsion spring system 122 forces the upper horizontal member 116 to move diametrically from the lower horizontal member 117. This diametric movement may allow the two outer vertical blocks 120 and the central vertical block 118 to tilt relative to the opposite motions of the upper and lower horizontal members 116, 117. As the central vertical block 118 and the two outer vertical blocks 120 tilt, the two outrigger skis 104 and the central ski 102 will tilt in the same direction, initiating a turn similar to a heel-side or toe-side turn on a snowboard or a left or right turn on skis. In other words, the upper horizontal member 116 may function as a pivot point or fulcrum and the lower horizontal member 117 moves to accommodate the horizontal force and the tilt caused by a rider's turning motion or manipulation of the steering mechanism 108. This horizontal force essentially results in a turn initiation motion similar to that of normal skis, which includes a bend or flex in all three skis and corresponding camber and allows a rider to carve into the mountain and hold a turn. Camber refers to the slight convexity, arching, or curvature of a ski or snowboard. The relative turn initiation on the scooter 100 is similar to the turn initiation of both skis and snowboards, which would allow a rider, such as a young child, to get a feel for the turning movements and maneuvering down a mountain slope before having to get on actual skis or snowboards.

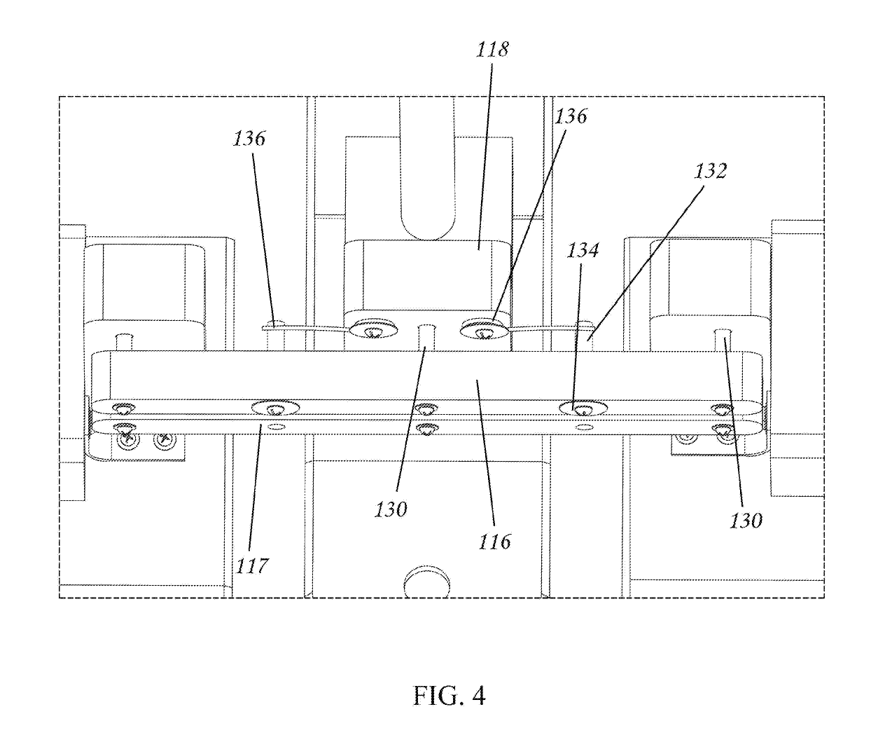

FIG. 4 show an isometric perspective view depicting the torsion spring system 122. The scooter 100 may have a torsion spring system 122 that may be attached to the parallelogram suspension 114 by inserting an extension spacer column 130 through the upper and lower horizontal members 116, 117. Each of the upper and lower horizontal members 116, 117 of the parallelogram suspension 114 may have three extension spacer columns 130, one for each of the two outer vertical blocks 120 and one for the central vertical block 118. The torsion spring system 122 may also have multiple stem 132 and head 134 components fastened to multiple springs 136 or coils. Each of the stem 132 and head 136 components prevent the spring 136 or coil from coming off of the stem 134. Each spring 136 may extend and rest on a separate extension spacer column 130 to provide resistance to tilt when a user is tilting the scooter 100 in order to prevent over-tilting.

The reader's attention is directed to all papers and documents which are filed concurrently with this specification and which are open to public inspection with this specification, and the contents of all such papers and documents are incorporated herein by reference.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example of a generic series of equivalent or similar features.

While embodiments have been illustrated and described, as noted above, many changes can be made without departing from the spirit and scope of the SKI SCOOTER DEVICE. Accordingly, the scope of the SKI SCOOTER DEVICE is not limited by the disclosure of these preferred and alternate embodiments. Instead, the scope of the SKI SCOOTER DEVICE may be determined entirely by reference to the claims. Insofar as the description above and the accompanying drawings (if any) disclose any additional subject matter that is not within the scope of the claims below, the inventions are not dedicated to the public and Applicant hereby reserves the right to file one or more applications to claim such additional inventions.

The reader's attention is directed to all papers and documents which are filed concurrently with this specification and which are open to public inspection with this specification, and the contents of all such papers and documents are incorporated herein by reference.

All the features disclosed in this specification (including any accompanying claims, abstract, and drawings) may be replaced by alternative features serving the same, equivalent, or similar purpose, unless expressly stated otherwise. Thus, unless expressly stated otherwise, each feature disclosed is one example of a generic series of equivalent or similar features.

Any element in a claim that does not explicitly state “means for” performing a specified function, or “step for” performing a specific function is not to be interpreted as a “means” or “step” clause as specified in 35. U.S.C. § 112 ¶ 6. In particular, the use of “step of” in the claims herein is not intended to invoke the provisions of U.S.C. § 112 ¶ 6.

What is claimed is:

1. A ski scooter device, comprising:
a central ski;
a plurality of outrigger skis;
a central platform;
a suspension system; and
a steering mechanism;
wherein the suspension system comprises a torsion spring system;
wherein the steering mechanism comprises a steering column.

2. The ski scooter device of claim 1, wherein the central ski comprises wood.

3. The ski scooter device of claim 1, wherein the central ski comprises plastic.

4. The ski scooter device of claim 1, wherein the plurality of outrigger skis comprises wood.

5. The ski scooter device of claim 1, wherein the plurality of outrigger skis comprises plastic.

6. The ski scooter device of claim 1, wherein the suspension system comprises a parallelogram suspension.

7. The ski scooter device of claim 6, wherein the parallelogram suspension comprises an upper horizontal member and a lower horizontal member, a central vertical block, and two outer vertical blocks.

8. The ski scooter device of claim 1, wherein the central platform comprises a coating to slough snow.

9. The ski scooter device of claim 8, wherein the coating to slough snow comprises grip tape.
